(19) United States
(12) Patent Application Publication
(10) Pub. No.: US 2007/0193451 A1
(43) Pub. Date: Aug. 23, 2007

(54) 12 Volt DC or Alkaline Battery Coffee Maker

(76) Inventors: Mark E. Brown, Simi Valley, CA (US); Wallis K. Brown, Simi Valley, CA (US)

Correspondence Address: Raymond M. Galasso;Galasso & Associates LP, P.O. Box 26503, Austin, TX, 78755-0503, US

(21) Appl. No.: 11/356,700

(22) Filed: Feb. 17, 2006

(51) Int. Cl. A47J 31/00

(52) U.S. Cl. 99/279

(57) ABSTRACT

The 12 Volt DC or Alkaline Battery Coffee Maker is a coffee maker that allows a user to utilize any of a variety of power sources. The 12 Volt DC or Alkaline Battery Coffee Maker is comprised of conventional coffee maker components along with a 12 Volt DC power cord that can be plugged into a car lighter, an alkaline battery compartment and an AC power cord with adaptor for use with conventional house outlets.

### CROSS REFERENCE TO RELATED APPLICATIONS

This Non-Provisional Patent Application does not claim priority to any United States Provisional Application or foreign patent application.

### FIELD OF THE DISCLOSURE

The disclosures made herein relate generally to coffee makers. The invention discussed herein is in the general classification of alternate powered coffee makers.

### BACKGROUND

When a person is traveling or away from a home or office, it is often difficult to find a suitable outlet for using many household appliances. For example, a traveler may desire to make coffee, but he may not have access to a standard AC outlet for use with a conventional coffee maker. This often occurs when a person is camping or simply driving across country.

None of the prior art in this field adequately addresses this problem. Previous attempts at providing a battery powered coffee maker have often failed because of the large energy requirement for one to boil a quantity of water. Prior patents involving battery powered coffee makers also do not disclose units capable of being used with multiple power sources, including a conventional AC outlet. Hence, there is a need in the art for a multi-powered coffee maker that can both be used when a user does not have access to a conventional AC outlet and yet still function with a standard AC outlet when appropriate.

### SUMMARY OF THE DISCLOSURE

In general, the 12 Volt DC or Alkaline Battery Coffee Maker allows the user to procure freshly brewed coffee no matter where he is located. The 12 Volt DC or Alkaline Battery Coffee Maker has a 12 Volt DC cord that can be plugged into the 12 Volt DC outlet found in most vehicles. The invention also has a standard AC power cord with an AC-DC adaptor that permits it to be used in homes and offices like any conventional coffee maker. In addition, it has an alkaline battery compartment that can power the coffee maker if no other power source is available.

In one embodiment of the invention, the 12 Volt DC or Alkaline Battery Coffee Maker includes a conventional coffee maker with a plastic frame, carafe, stainless steel reservoir and shell, heating plate, flip-open water bay, drip basket, power switch, battery compartment and DC and AC power cords along with appropriate electronic components.

The principal object of this invention is to provide a coffee maker that can be used when conventional AC power sources at a home or office are unavailable.

Another object of this invention is to provide an affordable and reliable coffee maker that can be powered by multiple sources.

Yet another object of this invention is to provide a lightweight and easily transported coffee maker that is re-usable.

### BRIEF DESCRIPTION OF THE DRAWINGS

FIG. 1 depicts a perspective view of the preferred embodiment of the 12 Volt DC or Alkaline Battery Coffee Maker.

### DETAILED DESCRIPTION OF THE DRAWINGS

The 12 Volt DC or Alkaline Battery Coffee Maker of the present invention is comprised of at least some of the following: a conventional coffee maker with a plastic frame, carafe, stainless steel reservoir and shell, heating plate, flip-open water bay, drip basket, power switch, battery compartment and DC and AC power cords along with appropriate electronic components.

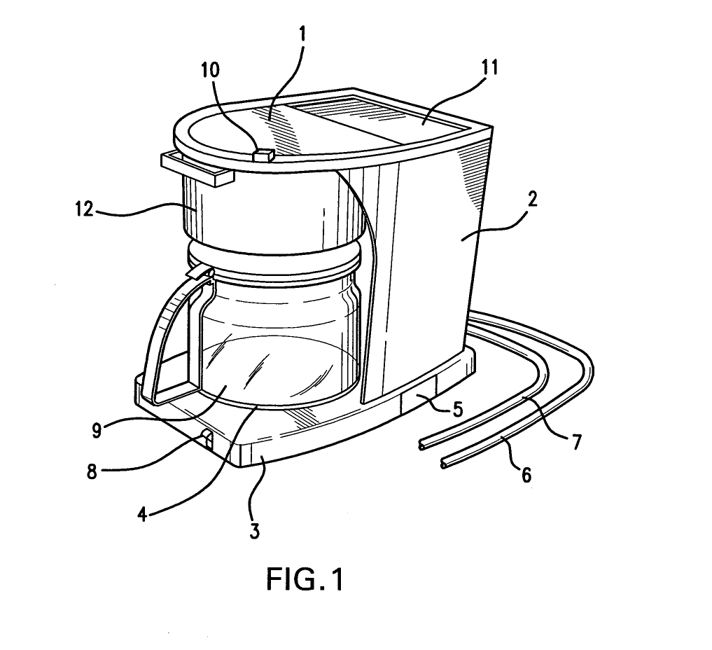

In the preferred embodiment of the invention, shown in FIG. 1, a plastic frame 1 is attached to a stainless steel outer shell 2 with a stainless steel inner shell reservoir (not pictured). The stainless steel outer shell 2 is connected to a base 3. A heating plate 4 is located on top of the base 3. The base 3 has a battery compartment 5 and an AC power cord 6 with an AC-DC adaptor (not pictured) and a DC power cord 7. A power switch 8 is also located on the front of the base 3. Appropriate electronic components (not pictured) are located within the plastic frame 1, base 3 and stainless steel outer shell 2. In this embodiment, the electronic components include a heating element (not pictured) used to heat water and the heating plate 4.

The plastic frame 1 has a power light 10 located in the front to allow a user to ascertain whether the coffee maker is connected to a power source. A flip-up lid 11 for pouring water into the coffee maker is located on top of the plastic frame 1. Also located beneath the plastic frame 1 is a removable drip basket 12. A carafe 9 can be placed under the removable drip basket 12 and on top of the heating plate 4. A tube (not pictured) can move liquid from the reservoir to the heating element in the base 3 and up to the removable drip basket 12. Alternatively, a pump (not pictured) can move liquid from the inner shell reservoir to the drip basket after it is heated. Consequently a tube may include a pump or pumping system.

The coffee maker may vary in size but often will measure approximately 14½ inches in height, 13½ inches in length, and 7 inches in width.

The 12 Volt DC or Alkaline Battery Coffee Maker is designed to allow the user to procure freshly brewed coffee by plugging the device into a 12 Volt DC outlet found in most vehicles, a standard AC outlet or through the use of an alkaline battery.

The components of the 12 Volt DC or Alkaline Battery Coffee Maker may vary but will likely utilize plastics, metal, and electronic components.

Ideally, the 12 Volt DC or Alkaline Battery Coffee Maker is constructed of the best quality materials commonly accepted and used in the manufacturing industry today. The metals would ideally be selected from available steel or alloys of steel and aluminum. The production process related to the use of these metals insures that the metal is non-corrosive, durable and strong. The selected metal should have high impact strength and be capable of accepting and retaining coloring materials for an extended length of time.

Plastic may be used in the production process of the 12 Volt DC or Alkaline Battery Coffee Maker. The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

The plastic components of the 12 Volt DC or Alkaline Battery Coffee Maker can also be formed with the use of plastic molding techniques, such as injection molding or blow molding. Injection molding requires melted plastic to be forcefully injected into relatively cool molds. As the plastic begins to harden, it takes on the shape of the mold cavity. This technique is ideal for the mass production of products. Alternatively, blow molding, a form of extrusion, could be utilized. Blow molding involves a molten tube being pushed into a mold. Compressed air then forces the molten tube against the cold walls of the mold.

All electronic components of the invention will also be ideally selected from those currently having the highest industry ratings. These components will also meet and/or exceed all safety and usage regulations. Wiring and associated connecting hardware should be insulated and otherwise protected from intrusion by any harmful or degrading elements, including water, medium level temperatures, and low to medium impact force.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A coffee maker comprising:
(a) a frame attached to an outer shell;
(b) an inner shell reservoir located within the outer shell;
(c) a base attached to the outer shell;
(d) said base being connected to a DC power cord;
(e) a plurality of electronic components located within at least the base;
(f) a drip basket located under the frame; and
(g) a tube within the inner shell reservoir capable of moving liquid from the inner shell reservoir to the drip basket.

2. The coffee maker of claim 1 wherein the base also has a battery compartment.

3. The coffee maker of claim 2 wherein the battery compartment can utilize rechargeable batteries.

4. The coffee maker of claim 1 further comprising
an AC power cord connected to the base and having an AC-DC adaptor.

5. The coffee maker of claim 1 wherein the outer shell and the inner shell reservoir are made of stainless steel.

6. The coffee maker of claim 1 wherein the frame is made of plastic.

7. The coffee maker of claim 1 further comprising
a power indicator located on the frame.

8. The coffee maker of claim 1 further comprising
a power switch located on the base.

9. The coffee maker of claim 1 further comprising
a flip-up lid on top of the frame.

10. The coffee maker of claim 1 further comprising
a heating plate located on top of the base.

11. The coffee maker of claim 10 wherein the heating plate is approximately circular in shape.

12. The coffee maker of claim 1 wherein the drip basket is removable.

13. The coffee maker of claim 10 further comprising
a carafe placed under the drip basket and above the heating plate.

14. A coffee maker comprising:
(a) a frame attached to an outer shell;
(b) an inner shell reservoir located within the frame;
(c) a base attached to the outer shell;
(d) said base being connected to a DC power cord;
(e) a plurality of electronic components located within the frame, the outer shell, and the base; and
(f) a drip basket located under the frame.

15. A coffee maker comprising:
(a) a plastic frame attached to a stainless steel outer shell;
(b) a stainless steel inner shell reservoir located within the stainless steel outer shell;
(c) a base attached to the stainless steel outer shell and having a heating plate located on top;
(d) said base having a battery compartment and being connected to a DC power cord, and an AC power cord with an AC-DC adaptor;
(e) a plurality of electronic components located within the plastic frame, the stainless steel outer shell, and the base.
(f) a flip-up lid on top of the plastic frame;
(g) a removable drip basket located under the plastic frame;
(h) a power indicator located on the plastic frame;
(i) a power switch located on front of the base;
(j) a carafe located under the removable drip basket and above the heating plate.
(k) A tube within the stainless steel inner shell reservoir capable of moving liquid from the stainless steel inner shell reservoir to the removable drip basket.
